(19) United States
(12) Patent Application Publication
(10) Pub. No.: US 2026/0197025 A1
(43) Pub. Date: Jul. 9, 2026

(54) Digital-to-Analog Converter with Multi-Tap Matching Networks

(71) Applicant: Apple Inc., Cupertino, CA (US)

(72) Inventor: Antonio Passamani, Munich (DE)

(21) Appl. No.: 19/015,445

(22) Filed: Jan. 9, 2025

(51) Int. Cl. H04B 1/40

(52) U.S. Cl. CPC H04B 1/40

(57) ABSTRACT

An electronic device may include a radio-frequency digital-to-analog converter (RFDAC), an amplifier, and matching circuitry between the RFDAC and the amplifier. The matching circuitry may include a first network tuned to a first band and a second network tuned to a second band. The first network may be coupled to a first tap and the second network may be coupled to a second tap of the RFDAC. The first network may include a first transformer with a first primary coil coupled in series between terminals of the first tap. The second network may include a second transformer with a second primary coil coupled in series between terminals of the second tap. The first and second primary coils may include series switches that selectively activate the first and second networks, respectively. The first and second primary coils may also include series-coupled adjustable inductors and/or capacitors to perform fine tuning.

### FIELD

This disclosure relates generally to electronic devices, including electronic devices with wireless communications circuitry.

### BACKGROUND

Electronic devices can be provided with wireless communications capabilities. An electronic device with wireless communications capabilities has wireless communications circuitry with one or more antennas. Wireless transceiver circuitry in the wireless communications circuitry uses the antennas to transmit and receive radio-frequency signals.

Radio-frequency signals transmitted by an antenna can be fed through a radio-frequency digital-to-analog converter that performs both signal domain conversion and frequency upconversion. It can be challenging to provide radio-frequency digital-to-analog converters with sufficient levels of performance over a wide range of operating frequencies.

### SUMMARY

An electronic device may include wireless circuitry. The wireless circuitry may include a radio-frequency transmit path. The transmit path may include processing circuitry, a radio-frequency digital-to-analog converter (RFDAC), an amplifier, and an antenna. The transmit path may transmit a baseband signal. The RFDAC may generate a radio-frequency signal based on the baseband signal. The amplifier may amplify the radio-frequency signal. The antenna may radiate the radio-frequency signal. Matching circuitry between the RFDAC and the amplifier may perform impedance matching between the RFDAC and the amplifier across a relatively wide frequency range.

The matching circuitry may include a first matching network tuned to a first frequency band and a second matching network tuned to a second frequency band lower than the first frequency band. The first matching network may be coupled to a first tap of the RFDAC. The second matching network may be coupled to a second tap of the RFDAC. The RFDAC may exhibit higher series inductance to the second matching network than to the first matching network. The first matching network may include a first transformer with a first primary coil coupled in series between terminals of the first tap. The second matching network may include a second transformer with a second primary coil coupled in series between terminals of the second tap. The first and second primary coils may include series switches that selectively activate the first and second matching networks, respectively. The first and second primary coils may also include series-coupled adjustable inductors and/or capacitors to perform fine tuning. This may be generalized to N matching networks coupled to N taps of the RFDAC.

An aspect of the disclosure provides wireless circuitry. The wireless circuitry can include a digital-to-analog converter (DAC) circuit that includes a signal path configured to output an analog radio-frequency signal. The wireless circuitry can include a first matching network that includes a first transformer with a first primary coil coupled to the signal path at a first tap of the DAC circuit, the first matching network being tuned to a first frequency band. The wireless circuitry can include a second matching network that includes a second transformer with a second primary coil coupled to the signal path at a second tap of the DAC circuit, the second matching network being tuned to a second frequency band lower than the first frequency band.

An aspect of the disclosure provides wireless circuitry. The wireless circuitry can include a digital-to-analog converter (DAC) that includes a differential signal path having a positive signal line and a negative signal line configured to output an analog radio-frequency signal. The wireless circuitry can include a first transformer that includes a first primary coil and a first secondary coil, wherein the first primary coil is coupled in series between the positive signal line and the negative signal line, the first secondary coil is coupled between a reference potential and an output load, and the first transformer is tuned to a first frequency band. The wireless circuitry can include a second transformer that includes a second primary coil and a second secondary coil, wherein the second primary coil is coupled in series between the positive signal line and the negative signal line in parallel with the first primary coil, the second secondary coil is coupled between the reference potential and the output load, and the second transformer is tuned to a second frequency band lower than the first frequency band.

An aspect of the disclosure provides wireless circuitry. The wireless circuitry can include a digital-to-analog converter (DAC) that includes a differential signal path having a first line and a second line configured to output an analog radio-frequency signal, a first inductor coupled in series between the first line and a first terminal of the DAC, a second inductor coupled in series between the first line and a second terminal of the DAC, a third inductor coupled in series between the second line and a third terminal of the DAC, and a fourth inductor coupled in series between the second line and a fourth terminal of the DAC. The wireless circuitry can include a transformer that includes a first coil coupled in series between the first terminal and the second terminal, a second coil coupled in series between the third terminal and the fourth terminal, and a third coil coupled in series between a reference potential and an output load and that is electromagnetically coupled to the first coil and the second coil.

### BRIEF DESCRIPTION OF THE DRAWINGS

FIG. 1 is a diagram of an illustrative electronic device having wireless circuitry in accordance with some embodiments.

FIG. 2 is a diagram of illustrative wireless circuitry having radio-frequency amplifiers in accordance with some embodiments.

FIG. 3 is a diagram of illustrative transmit circuitry that includes a radio-frequency digital-to-analog converter (RFDAC) in accordance with some embodiments.

FIG. 4 is a circuit diagram of an illustrative multi-tapped RFDAC that is provided with multiple matching networks in accordance with some embodiments.

FIG. 5 is a circuit diagram showing one example of how an illustrative multi-tapped RFDAC may be tapped by a matching network multiple times in accordance with some embodiments.

FIG. 6 is a circuit diagram of an illustrative multi-tapped RFDAC that is provided with multiple matching networks having series-coupled tuning components in accordance with some embodiments.

FIG. 7 is a floorplan diagram showing how an illustrative multi-tapped RFDAC may be interposed on a substrate between different matching networks in accordance with some embodiments.

FIG. 8 is a floorplan diagram showing how a matching network for an illustrative multi-tapped RFDAC may be interposed on a substrate between the RFDAC and another matching network in accordance with some embodiments.

FIG. 9 is a flow chart of illustrative operations involved in transmitting radio-frequency signals using a multi-tapped RFDAC of the types shown in FIGS. 3-8 in accordance with some embodiments.

FIG. 10 is plot illustrating the gain of an illustrative multi-tapped RFDAC of the types shown in FIGS. 3-8 under different configurations in accordance with some embodiments.

### DETAILED DESCRIPTION

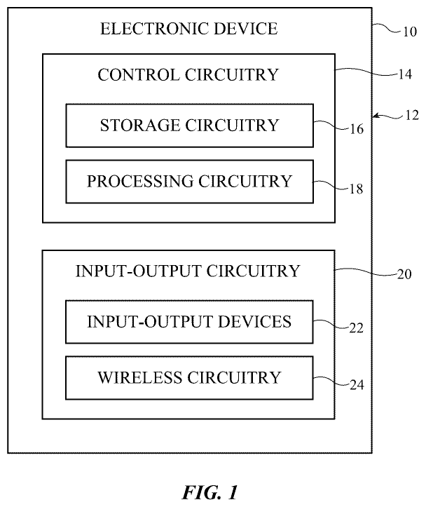

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, a helmet, or other equipment worn on a user's head (e.g., an augmented, virtual, or mixed reality head-mounted display device), or another wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed from plastic, glass, ceramics, fiber composites, metal (e.g., stainless steel, aluminum, metal alloys, etc.), other suitable materials, or a combination of these materials. In some embodiments, parts or all of housing 12 may be formed from dielectric or other low-conductivity material (e.g., glass, ceramic, plastic, sapphire, etc.). In other embodiments, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols - sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), satellite communications (satcom) protocols, antenna-based spatial ranging protocols, optical communications protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support or perform radio-frequency signal transmission and/or reception for device 10. Wireless circuitry 24 may be used for wireless communications. Wireless communications performed by wireless circuitry 24 may include or involve wireless data communications (e.g., where wireless data is carried by radio-frequency signals conveyed between wireless circuitry 24 and other communications equipment bidirectionally or unidirectionally), radio-frequency signal transmission, radio-frequency signal reception, and/or radio-based spatial ranging/sensing (e.g., radio detection and ranging (radar) operations, shorter range object detection such as near-field radio-frequency signal-based object detection, etc.). Radio-frequency signals conveyed by wireless circuitry 24 may include or carry wireless data (e.g., organized into frames, packets, symbols, datagrams, etc.), radar or other spatial ranging waveforms, continuous wave signals, chirp signals, control signals, management signals, reference signals, beacon signals, tones, pulses/impulses, waveforms associated with one or more communications protocols, and/or any other radio-frequency waveforms or signals. Wireless circuitry 24 is sometimes also referred to herein as wireless communications circuitry 24, wireless communication circuitry 24, communications circuitry 24, or simply as circuitry 24. Wireless circuitry 24 may include one or more antennas. Wireless circuitry 24 may also include baseband processor circuitry, transceiver circuitry, amplifier circuitry, filter circuitry, switching circuitry, radio-frequency transmission lines, and/or any other circuitry for transmitting and/or receiving radio-frequency signals using the antenna(s). Some or all of the components of wireless circuitry 24 may be disposed on, mounted to, communicatively coupled to, and/or integrated within the same substrate (e.g., a printed circuit board, semiconductor substrate, chip, integrated circuit (IC), IC packages, etc.) or may be distributed between two or more substrates (e.g., printed circuit boards, semiconductor substrates, chips, ICs, IC packages, etc.).

Wireless circuitry 24 may transmit and/or receive radio-frequency signals within a corresponding frequency band at radio frequencies (sometimes referred to herein as a communications band or simply as a “band”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1 ) bands below 10 GHz, 5G New Radio Frequency Range 2 (FR2) bands between 20 and 60 GHz, etc.), other centimeter or millimeter wave frequency bands between 10-100 GHz, sub-THz frequency bands between around 100 GHz and 10 THz (e.g., 6G bands), near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, satellite communications (satcom) bands (e.g., an IEEE C band (4-8 GHz), S band (2-4 GHz), L band (1-2 GHz), X band (8-12 GHz), W band (75-110 GHz), V band (40-75 GHz), K band (18-27 GHz), K_{a band (}26.5-40 GHz), K_{u band (}12-18 GHz), etc.), unlicensed bands, communications bands under the family of 3GPP wireless communications standards, communications bands under the IEEE 802.XX family of standards, and/or any other desired frequency bands of interest.

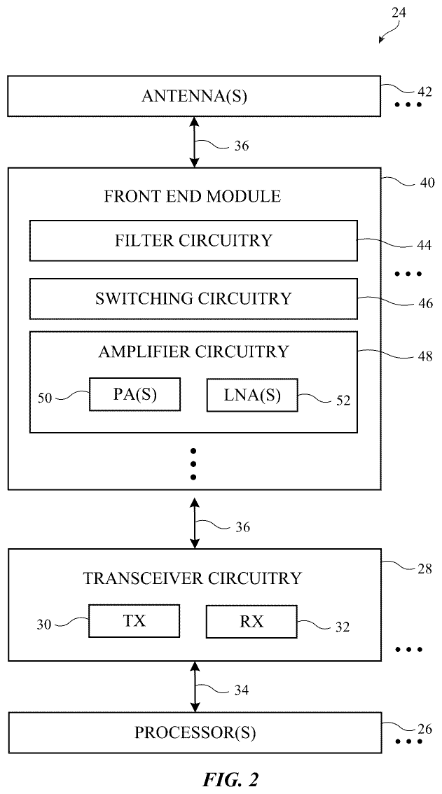

FIG. 2 is a diagram showing illustrative components within wireless circuitry 24. As shown in FIG. 2, wireless circuitry 24 may include a processor such as processor 26, radio-frequency (RF) transceiver circuitry such as radio-frequency transceiver 28, radio-frequency front end circuitry such as radio-frequency front end module (FEM) 40, and antenna(s) 42. Processor 26 may be a baseband processor, application processor, general purpose processor, microprocessor, microcontroller, digital signal processor, host processor, application specific signal processing hardware, or other type of processor. Processor 26 may be coupled to transceiver 28 over path 34. Transceiver 28 may be coupled to antenna 42 via radio-frequency transmission line path 36. Radio-frequency front end module 40 may be disposed on radio-frequency transmission line path 36 between transceiver 28 and antenna 42.

In the example of FIG. 2, wireless circuitry 24 is illustrated as including only a single processor 26, a single transceiver 28, a single front end module 40, and a single antenna 42 for the sake of clarity. In general, wireless circuitry 24 may include any desired number of processors 26, any desired number of transceivers 28, any desired number of front end modules 40, and any desired number of antennas 42. Each processor 26 may be coupled to one or more transceiver 28 over respective paths 34. Each transceiver 28 may include a transmitter circuit 30 configured to output uplink signals to antenna 42, may include a receiver circuit 32 configured to receive downlink signals from antenna 42, and may be coupled to one or more antennas 42 over respective radio-frequency transmission line paths 36. Each radio-frequency transmission line path 36 may have a respective front end module 40 disposed thereon. If desired, two or more front end modules 40 may be disposed on the same radio-frequency transmission line path 36. If desired, one or more of the radio-frequency transmission line paths 36 in wireless circuitry 24 may be implemented without any front end module disposed thereon.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path such that is coupled to the positive antenna feed terminal on antenna 42. Radio-frequency transmission line path 36 may have a ground transmission line signal path that is coupled to the ground antenna feed terminal on antenna 42. This example is illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include transmission lines that are used to route radio-frequency antenna signals within device 10 (FIG. 1). Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 36 may be integrated into rigid and/or flexible printed circuit boards.

In performing wireless transmission, processor 26 may provide transmit signals (e.g., digital or baseband signals) to transceiver 28 over path 34. Transceiver 28 may further include circuitry for converting the transmit (baseband) signals received from processor 26. For example, transceiver circuitry 28 may include mixer circuitry for up-converting (or modulating) the transmit (baseband) signals to radio frequencies prior to transmission over antenna 42. The example of FIG. 2 in which processor 26 communicates with transceiver 28 is illustrative. In general, transceiver 28 may communicate with a baseband processor, an application processor, general purpose processor, a microcontroller, a microprocessor, or one or more processors within circuitry 18. Transceiver circuitry 28 may also include digital-to-analog converter (DAC) and/or analog-to-digital converter (ADC) circuitry for converting signals between digital and analog domains. Transceiver 28 may use transmitter (TX) 30 to transmit the radio-frequency signals over antenna 42 via radio-frequency transmission line path 36 and front end module 40. Antenna 42 may transmit the radio-frequency signals to external wireless equipment by radiating the radio-frequency signals into free space.

In performing wireless reception, antenna 42 may receive radio-frequency signals from the external wireless equipment. The received radio-frequency signals may be conveyed to transceiver 28 via radio-frequency transmission line path 36 and front end module 40. Transceiver 28 may include circuitry such as receiver (RX) 32 for receiving signals from front end module 40 and for converting the received radio-frequency signals into corresponding baseband signals. For example, transceiver 28 may include mixer circuitry for down-converting (or demodulating) the received radio-frequency signals to baseband frequencies prior to conveying the received signals to processor 26 over path 34.

Front end module (FEM) 40 may include radio-frequency front end circuitry that operates on the radio-frequency signals conveyed (transmitted and/or received) over radio-frequency transmission line path 36. FEM 40 may, for example, include front end module (FEM) components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifiers 50 and/or one or more low-noise amplifier circuits 52), signal attenuators, impedance matching circuitry (e.g., circuitry that helps to match the impedance of antenna 42 to the impedance of radio-frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front end module components may be mounted to a common (shared) substrate such as a rigid printed circuit board substrate or flexible printed circuit substrate. If desired, the various front end module components may also be integrated into a single integrated circuit chip. If desired, amplifier circuitry 48 and/or other components in front end 40 such as filter circuitry 44 may also be implemented as part of transceiver circuitry 28.

Filter circuitry 44, switching circuitry 46, amplifier circuitry 48, and other circuitry may be disposed along radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to adjust the frequency response and wireless performance of antenna 42 over time.

Transceiver 28 may be separate from front end module 40. For example, transceiver 28 may be formed on another substrate such as the main logic board of device 10, a rigid printed circuit board, or flexible printed circuit that is not a part of front end module 40. While control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, processor 26 and/or portions of transceiver 28 (e.g., a host processor on transceiver 28) may form a part of control circuitry 14. Control circuitry 14 (e.g., portions of control circuitry 14 formed on processor 26, portions of control circuitry 14 formed on transceiver 28, and/or portions of control circuitry 14 that are separate from wireless circuitry 24) may provide control signals (e.g., over one or more control paths in device 10) that control the operation of front end module 40.

Transceiver 28 may include wireless local area network transceiver circuitry that handles WLAN communications bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network transceiver circuitry that handles the 2.4 GHz Bluetooth® band or other WPAN communications bands, cellular telephone transceiver circuitry that handles cellular telephone bands (e.g., bands from about 600 MHz to about 5 GHz, 3G bands, 4G LTE bands, 5G New Radio Frequency Range 1(FR1 ) bands below 10 GHz, 5G New Radio Frequency Range 2 (FR2) bands between 20 and 60 GHz, 6G bands above 100 GHz, etc.), near-field communications (NFC) transceiver circuitry that handles near-field communications bands (e.g., at 13.56 MHz), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband communications protocols, and/or any other desired radio-frequency transceiver circuitry for covering any other desired communications bands of interest.

Wireless circuitry 24 may include one or more antennas such as antenna 42. Antenna 42 may be formed using any desired antenna structures. For example, antenna 42 may be an antenna with a resonating element that is formed from loop antenna structures, patch antenna structures, inverted-F antenna structures, slot antenna structures, planar inverted-F antenna structures, helical antenna structures, monopole antennas, dipoles, hybrids of these designs, etc. Two or more antennas 42 may be arranged into one or more phased antenna arrays (e.g., for conveying radio-frequency signals at millimeter wave frequencies). Parasitic elements may be included in antenna 42 to adjust antenna performance. Antenna 42 may be provided with a conductive cavity that backs the antenna resonating element of antenna 42 (e.g., antenna 42 may be a cavity-backed antenna such as a cavity-backed slot antenna).

As described above, front end module 40 may include one or more power amplifiers (PAs) 50 in the transmit (uplink) path. A power amplifier 50 (sometimes referred to as a radio-frequency power amplifier, transmit amplifier, or amplifier) may be configured to amplify a radio-frequency signal without changing the signal shape, format, or modulation. Amplifier 50 may, for example, be used to provide 10 dB of gain, 20 dB of gain, 10-20 dB of gain, less than 20 dB of gain, more than 20 dB of gain, or other suitable amounts of gain.

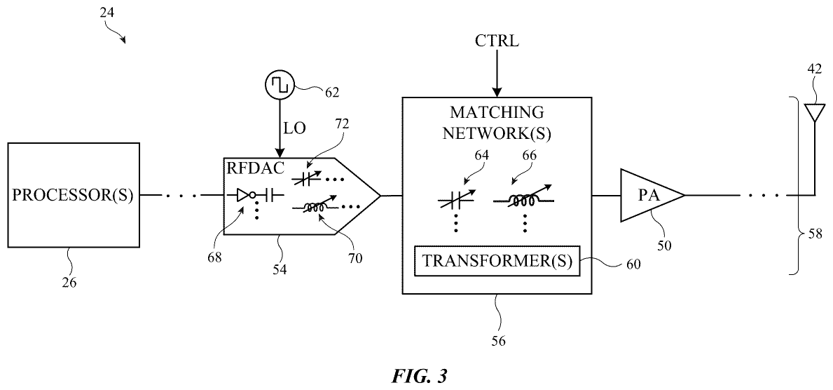

FIG. 3 is a diagram of an illustrative transmit path 58 of wireless circuitry 24. Transmit path 58 is sometimes also referred to herein as transmit chain 58 or transmit circuitry 58. As shown in FIG. 3, wireless circuitry 24 may include processing circuitry such as one or more processors 26, a radio-frequency converter block such as radio-frequency converter block 54, radio-frequency amplifier circuitry such as radio-frequency amplifier 50 (e.g., a power amplifier), impedance matching circuity such as one or more matching networks 56, and an antenna 42 configured to radiate radio-frequency signals output by amplifier 50. Matching network(s) 56 may be coupled between the output of radio-frequency converter block 54 (e.g., between one or more radio-frequency terminals, ports, taps, or outputs of radio-frequency converter block 54) and the input of amplifier 50. Additional components (not shown) may also be disposed at different locations along transmit path 58 if desired.

Amplifier 50 may be disposed on FEM 40 or in transceiver circuitry 28 of FIG. 2. Processor(s) 26 may represent one or more processors such as a baseband processor, an application processor, a digital signal processor, a microcontroller, a microprocessor, a central processing unit (CPU), a programmable device, a combination of these circuits, and/or one or more processors within circuitry 18 of FIG. 1. Processor(s) 26 may be configured to generate a digital baseband signal (e.g., a stream of digital data bits at baseband). The baseband signal is sometimes referred to as a digital signal or a transmit signal. As examples, the baseband signal generated by processor(s) 26 may include in-phase and quadrature-phase signals, radius and phase signals, a vector input, or other digitally coded signals.

Radio-frequency converter block 54 may be configured to convert the digital baseband signal from the digital domain to the analog domain and to upconvert (modulate) the analog signals to radio frequencies. The term “radio-frequency converter” may thus refer to and be defined herein as a circuit that can perform both signal domain conversion (e.g., digital to analog conversion) and frequency upconversion (e.g., from baseband frequencies to radio frequencies or intermediate frequencies). The input of amplifier 50 configured to receive radio-frequency signals can be referred to or defined herein as a radio-frequency input (port). Radio frequencies can range from a few kHz to tens of THz. Radio-frequency converter block 54 may output a radio-frequency signal to the radio-frequency input of amplifier 50 via matching network(s) 56. Matching network(s) 56 may perform impedance matching between the output of radio-frequency converter block 54 and the input of amplifier 50 at the frequencies of the radio-frequency signal. Amplifier 50 may generate a corresponding amplified radio-frequency signal that can then be radiated by antenna(s) 42.

The example described above in which converter block 54 performs digital-to-analog conversion before conducting frequency upconversion in the analog domain is illustrative. In another embodiment, RF converter block 54 can perform frequency upconversion in the digital domain before conducting digital-to-analog conversion. In general, RF converter block 54 may include a set of N individual digital-to-analog converter (DAC) circuits or DACs, each of which is sometimes referred to or defined herein as a radio-frequency digital-to-analog converter (RFDAC) cell (e.g., converter block 54 can include N separate RFDAC cells). For example, N can be any integer greater than or equal to one, two, four, four to ten, greater than 10, 10 to 20, greater than 20, or another integer value. RF converter block 54 is sometimes also referred to herein as RFDAC circuitry 54 or RFDAC 54. RFDAC 54 may contain a set of one or more individual RFDAC cells. An RFDAC cell is sometimes also referred to on its own as an RFDAC tile or simply as an RFDAC.

RFDAC 54 may include one or more converter signal paths 68 (e.g., signal processing/conversion branches containing digital logic gates, inverters, and/or other components that drive corresponding series-coupled capacitors). If desired, RFDAC 54 may also include one or more capacitors 72 (e.g., fixed and/or adjustable capacitors) coupled between signal paths 68 and the output of RFDAC 54 (e.g., in series). If desired, RFDAC 54 may also include one or more inductors 70 (e.g., fixed or adjustable inductors) coupled between signal paths 68 and the output of RFDAC 54 (e.g., in series). Capacitors 72 and/or inductors 70 may, for example, help to tune the operating frequencies of RFDAC 54 and the radio-frequency signals that are output by RFDAC 54 to amplifier 50 via matching network(s) 56. RFDAC 54 may be driven using one or more clocking signals such as local oscillator signals LO to convert digital data received from processor 26 into radio-frequency signals (e.g., radio-frequency signals carrying wireless data such as a series of data packets). RFDAC 54 may receive local oscillator signals LO from clocking circuitry 62. Clocking circuitry 62 may include local oscillator circuitry, phase locked loop circuitry, voltage controlled oscillator circuitry, crystal oscillator circuitry, an off-chip oscillator, frequency locked loop circuitry, and/or other types of signal generator for outputting a clock signal, a sinusoidal waveform, or other periodic signal as local oscillator signals LO.

Matching network(s) 56 may perform impedance matching between the output of RFDAC 72 and the input of amplifier 50 (e.g., to maximize the power or transfer of radio-frequency energy provided to PA 50). Matching network(s) 56 may include, for example, one or more transformers 60. Transformers 60 may form one or more baluns that perform differential-to-single ended signal conversion in some implementations. If desired, matching network(s) 56 may also include one or more fixed or adjustable inductors such as inductors 66 and/or may include one or more fixed or adjustable capacitors such as capacitors 64. Capacitors 64 and inductors 66 may form a part of one or more transformers 60 or may be separate from transformers 60. Matching network(s) 56 may receive a control signal CTRL (e.g., from processor 26) that controls one or more adjustable components in the matching network(s) (e.g., switches, capacitors 64, inductors 66, etc.). Control signal CTRL may adjust the components of matching network(s) 56 over time as the frequency of the radio-frequency signals transmitted over transmit path 58 change over time (e.g., to perform suitable impedance matching for that frequency between RFDAC 54 and amplifier 50).

In practice, it can be difficult to configure transmit path 58 to transmit radio-frequency signals with sufficient levels of performance (e.g., sufficient output power levels) over a relatively wide bandwidth (e.g., from around 700 MHz to around 7 GHz or higher frequencies). In some implementations, which are sometimes described herein as an example, RFDAC 54 may include one or more control DACs (CDACs or C-DACs). In some implementations, a CDAC may be cascaded with a wideband matching network to provide the transmit path with a wide range of operational frequencies. However, this approach can result in less power being output by the RFDAC than in implementations where the matching circuitry is narrowband (e.g., containing a capacitor and an inductor tuned for a very limited set of frequencies).

In some situations, to help achieve sufficient output power across a wide range of operational frequencies, the transmit path may include multiple different transceivers each tuned to a respective frequency. In these scenarios, a set of front end switches may selectively activate different transceivers as needed depending on the transmit frequency to be used. Although these types of implementations can ensure sufficient output power level across a wide range of frequencies, implementing multiple different transceivers for different frequencies consumes an excessive amount of area (e.g., chip space) in wireless circuitry 24, can cause wireless circuitry 24 to consume excessive power, and can substantially increase the local oscillator routing complexity of the wireless circuitry.

A tunable matching network can be used to cover multiple different frequencies if the matching network exhibits fine tuning of its center frequency. These types of matching networks may include tunable inductors and fixed capacitors instead of tunable capacitors, which can otherwise be a source of signal degradation. However, matching networks that exhibit constant capacitance and tuned inductance still exhibit maximum efficiency over a relatively limited range of frequencies (e.g., when the matching network is of third order only). When implementing a fourth order matching network, this issue can be overcome by adding an additional degree of freedom in the system (e.g., using programmable series inductances and capacitances) to achieve multiple resonant frequencies with high efficiency.

Consider an example in which RFDAC 54 includes tunable inductors 70 coupled in series between signal paths 68 of a CDAC and the output of RFDAC 54 for tuning the operating frequency of RFDAC 54. The tunable inductors may introduce series inductance at the output of the CDAC, which may increase the effective capacitance C of the CDAC. This may produce an equivalent impedance of Zeq=(1/jωC)+jωL=(1/jω)*(1/(C/(1−ω²LC))), where ω is angular frequency and j is the square root of −1. The effective capacitance C is scaled by a factor k=1/(1−ω²LC), where a larger equivalent capacitance C is observed when a larger series inductance is applied. For example, for a DAC's capacitor of 8 pF per differential branch each and a series inductance of 250 pH, at 2.5 GHz, k is approximately equal to 2 (e.g., producing an effective capacitance C of around 16 pF). Note that the equivalence only holds at a specific frequency of interest.

To achieve a finer frequency sweep, in some implementations, a string of inductors with multiple injection points may be coupled between signal paths 68 and the output of the RFDAC (e.g., in a binary ladder configuration). In these implementations, every switch adds a capacitance to ground so only a limited number of switches needs to be placed based on tuning needs. To maximize tunability, a binary encoded series inductance made from several inductor segments of different lengths, each with an independent short through a programable switch, may be used to maximize tunability with a minimum added parasitic capacitance load. However, when accepting asymmetry between positive and negative branches of the DAC, a wider tuning range may be achieved. If the positive and negative switches are controlled independently, then a larger tuning range may be obtained compared to operating positive and negative branches asymmetrically.

In other implementations, the output of the DAC may be coupled to a transformer (e.g., transformer 60 in matching network(s) 56) having switchable inductors coupled in series on the center tap of the primary coil of the transformer. Short paths may be coupled between the switches to minimize inductance through the path. The switches may be placed one next to each other in a line and may collect from inductances that branch sideways, the inductances being of varying length based on the tap weight desired. In this configuration, the value of the inductance is comparable to the value of the capacitance seen differentially through the DAC, not the capacitance of the individual branches. As such, an effective half capacitance is observed and compares to the introduced inductance.

As another example, the effective capacitance C of the DAC may be achieved by inserting series capacitance (e.g., capacitor(s) 72) between signal paths 58 and the output of RFDAC 54. A series capacitance reduce the total effective capacitance C seen, calculated as Z=(1/jωC)(30 (1/ωCₛ)=(C+Cₛ)/(jωCₛ), where Cₛ is the series capacitance. In addition, Z=1/(jωC(1/(1+C/Cₛ))). Therefore, k can be defined by k=1/(1+C/Cₛ) as scaling factor. For example, if C and Cₛ are both 16 pF, the resulting k is given by k=(1/(1+1))=1/2. As such, an effective capacitance of 8 pF is observed. Unlike the series inductance technique described above, this series capacitance technique is frequency independent. As such, the DAC can maintain similar behavior across the entire frequency range.

As another example, if desired, there may be a set of switchable capacitors (e.g., capacitors coupled in series with switches) of different sizes coupled in parallel along the center tap of the primary coil of the transformer coupled to the output of the DAC. This may, for example, allow for tuning to a very precise frequency. Note that under this architecture, the value of the inductance is comparable to the value of the capacitance seen differentially through the DAC, instead of the capacitance of individual branches. As such, an effective half capacitance is observed and compares to the introduced inductance. In addition, part of the parasitic capacitances in the system are referred to the center tap potential and, as such, do not detune the actual transformation opposed to when the series capacitance is instantiated per each differential branch. If desired, these two techniques can be combined to provide the capability to program both a higher capacitance and a lower capacitance as needed.

In implementations that are described herein as an example, the RFDAC may include a multi-tapped DAC. In these implementations, different matching networks 56 with different series inductances tuned for different frequency bands may tap the output of the RFDAC (e.g., may be coupled to different radio-frequency output taps, ports, or terminals of the RFDAC). Each tap may include a switch or may be free from switches (e.g., different taps may be selectively activated or deactivated if desired). Each matching network tapping the RFDAC may be tuned to a different frequency range of operation. For example, a more inductive tap and matching network may provide a path with a larger effective capacitance and may be suited for lower frequency operation (e.g., using a lower frequency-tuned matching network). On the other hand, a less inductive tap and matching network may provide the path with a lower effective capacitance and may be suited for higher frequency operation (e.g., using a higher frequency-tuned matching network).

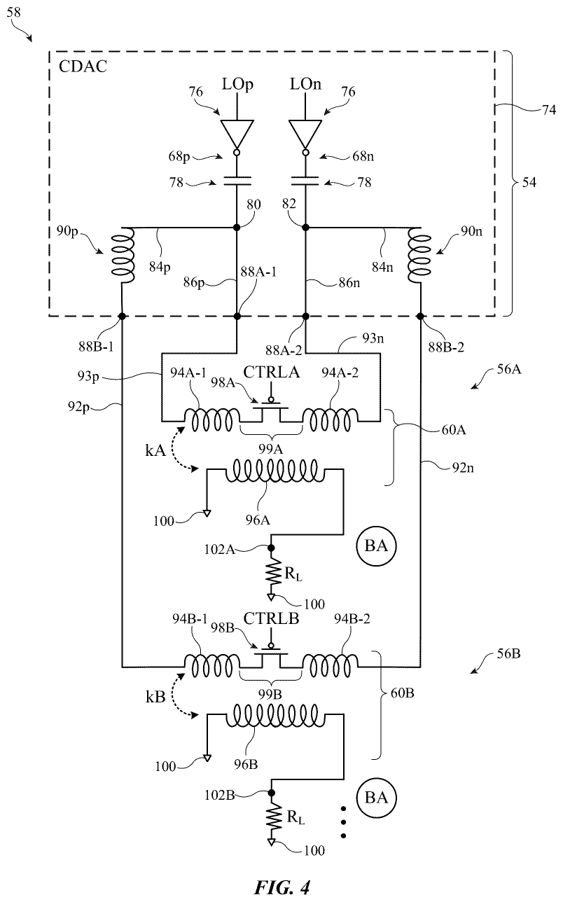

FIG. 4 is a circuit diagram showing one example of a transmit path 58 in which RFDAC 54 is tapped by multiple different matching networks 56 each optimized to a different respective frequency range. As shown in FIG. 4, RFDAC 54 may include a DAC circuit 74 (e.g., a given cell in an array of cells of RFDAC 54). DAC circuit 74 may be, for example, a CDAC or another type of DAC. DAC circuit 74 may include one or more signal paths 68. In the example of FIG. 4, DAC circuit 74 is a differential DAC that operates on and outputs differential signals (e.g., a differential signal pair). DAC circuit 74 may therefore include a differential signal path 68 that conveys differential signals (e.g., that outputs differential radio-frequency signals at the output of RFDAC 74). Differential signal path 68 may include signal lines 68p and 68n (e.g., a differential pair of signal lines forming differential signal path 68). Signal line 68p is sometimes referred to herein as positive signal line 68p or positive signal path 68p (e.g., carrying a positive signal of the differential signal pair). Signal line 68n is sometimes referred to herein as negative signal line 68n or negative signal path 68n (e.g., carrying a negative signal of the differential signal pair).

Signal line 68p and signal line 68n may each include one or more drivers 76 (e.g., inverters or other digital logic) coupled in series with one or more capacitors 78. The driver 76 in signal line 68p may, for example, receive a positive local oscillator signal LOp (e.g., in the local oscillator signals LO received from clocking circuitry 62 of FIG. 3). The driver 76 in signal line 68n may receive a negative local oscillator signal LOn (e.g., in the local oscillator signals LO received from clocking circuitry 62 of FIG. 3).

The output of signal line 68p may be coupled to a signal line (path) 84p and a signal line (path) 86p at circuit node 80 (e.g., signal lines 84p and 86p may be positive signal lines). The output of signal line 68n may be coupled to a signal line (path) 84n and a signal line (path) 86n at circuit node 82 (e.g., signal lines 84n and 86n may be negative signal lines). CDAC circuit 74 may have a set of output terminals that form at least two different radio-frequency output taps 88 of RFDAC 54. For example, CDAC circuit 74 may include a first differential radio-frequency output tap (port) 88A that includes terminals 88A-1 and 88A-2 and may include a second differential radio-frequency output tap (port) 88B that includes terminals 88B-1 and 88B-2. Terminals 88B-1 and 88A-1 may be positive terminals and terminals 88A-2 and 88B-2 may be negative terminals in the differential signal architecture shown in FIG. 4. Terminals 88A-1, 88A-2, 88B-1, and 88B-2 are sometimes also referred to herein as tap points, output terminals, or radio-frequency output terminals of CDAC circuit 74 or RFDAC 54. RFDAC 54 is sometimes also referred to herein as multi-tapped RFDAC 54.

Signal line 84p may couple circuit node 80 and thus signal line 68p to terminal 88B-1. Signal line 86p may couple circuit node 80 and thus signal line 68p to terminal 88A-1. Signal line 86n may couple circuit node 82 and thus signal line 68n to terminal 88A-2. Signal line 84n may couple circuit node 82 and thus signal line 68n to terminal 88B-2. CDAC circuit 74 may include series-coupled output tuning components such as inductors 90 coupled in series between signal lines 68p and 68n and terminals 88B-1 and 88B-2. Inductors 90 may include inductors 70 of FIG. 3 and may be fixed or tunable. For example, CDAC circuit 74 may include a first inductor 90p disposed on signal line 84p (e.g., coupled in series between circuit node 80 and terminal 88B-1). CDAC circuit 74 may also include a second inductor 90n disposed on signal line 84n (e.g., coupled in series between circuit node 82 and terminal 88B-2).

As shown in FIG. 4, the matching networks 56 (FIG. 3) coupled to the output of RFDAC 74 may include at least a first matching network 56A (sometimes also referred to herein as matching circuitry 56A or matching circuit 56A) and a second matching network 56B (sometimes also referred to herein as matching circuitry 56B or matching circuit 56B) that is different (separate) from matching network 56A. Matching network 56A may perform impedance matching and/or frequency tuning for RFDAC 54 in a first frequency band BA (e.g., the circuit components of matching network 56A may be tuned to frequencies in frequency band BA and/or may exhibit self-resonance in frequency band BA). Matching network 56B may perform impedance matching and/or frequency tuning for RFDAC 54 in a second frequency band BB (e.g., the circuit components of matching network 56B may be tuned to frequencies in frequency band BB and/or may exhibit self-resonance in frequency band BB). Frequency band BB may be, for example, lower than frequency band BA. This means that frequency band BB includes at least one frequency, channel, resource element, and/or range of frequencies that is lower in frequency than the lower limit of frequency band BB. The entirety of frequency band BB may be lower than the entirety of frequency band BB (e.g., frequency band BA may be completely non-overlapping with respect to frequency band BB in frequency) or, if desired, frequency band BB may partially overlap frequency band BA (e.g., frequency band BB may be partially overlapping and partially non-overlapping with respect to frequency band BA). Frequency band BA may extend from a first lower frequency limit (boundary) to a first upper frequency limit (boundary) that is higher than the first lower frequency limit. Frequency band BB may extend from a second lower frequency limit (boundary) to a second upper frequency limit (boundary) that is higher than the second lower frequency limit. The first upper frequency limit bounding frequency band BA may be lower than the second lower frequency limit bounding frequency band BB (e.g., when frequency bands BA and BB are completely non-overlapping) or may be greater than the second lower frequency limit but less than the second upper frequency limit bounding frequency band BB (e.g., when frequency bands BA and BB are partially overlapping). When frequency bands BA and BB are partially overlapping (intersecting), one or more frequencies, a frequency sub-range, one or more channels, and/or other frequency resources may be shared by both frequency bands BA and BB (e.g., a mutual/overlapping frequency spectrum at frequencies greater than the first upper frequency limit and lower than the second lower frequency limit may belong to both frequency bands). As one example, frequency band BA may be a high band at relatively high frequencies such as frequencies greater than or equal to around 3-4 GHz and frequency band BB may be a low band at relatively low frequencies such as frequencies less than around 3-4 GHz. Frequency band BA is sometimes also referred to herein as high band BA and frequency band BB is sometimes also referred to herein as low band BB. To support operations at lower frequencies such as frequencies in frequency band BB, the inductive components (e.g., coils) in matching network 56B may be larger than the inductive components in matching network 56A, for example.

Matching network 56A may include a first transformer 60A. Transformer 60A may include a first coil such as primary coil 94A (sometimes also referred to herein as first/primary winding 94A or first/primary inductor 94A). Transformer 60A may also include a second coil such as secondary coil 96A (sometimes also referred to herein as second/secondary winding 96A or second/secondary inductor 96A). Primary coil 94A may extend from a first terminal to a second terminal. The first terminal of primary coil 94A may be coupled to terminal 88A-1 of DAC circuit 74 over signal line 93p (e.g., a positive signal line). The second terminal of primary coil 94A may be coupled to terminal 88A-2 of DAC circuit 74 over signal line 93n (e.g., a negative signal line). Put differently, primary coil 94A may be coupled to the differential output tap 88A of RFDAC 54 (e.g., transformer 60A and matching network 56A may tap RFDAC 54 at tap 88A such that primary coil 94A is coupled in series between terminals 88A-1 and 88A-2).

Secondary coil 96A may extend from a first terminal to a second terminal. The first terminal of secondary coil 96A may be coupled to reference potential 100 (e.g., a ground voltage or another reference voltage). The second terminal of secondary coil 96A may be coupled to output terminal 102A of matching network 56A. Output terminal 102A may be coupled to an output load R_{L} of matching network 56A (e.g., modeled as a series resistance between output terminal 102A and reference potential 100 for the sake of simplicity). Output load R_{L} may include some or all of amplifier 50 (FIG. 3), antenna 42, or another component in transmit path 58.

Primary coil 94A may have a center tap 99A (e.g., a center tap path, contact, or conductor). Center tap 99A may separate a first portion 94A-1 of primary coil 94A (e.g., one, more than one, or less than one turn, winding, or loop of conductive material in primary coil 94A) form a second portion 94A-2 of primary coil 94A (e.g., one, more than one, or less than one turn, winding, or loop of conductive material in primary coil 94A). Portion 94A-1 may extend from signal line 93p (e.g., the first terminal of primary coil 94A) to center tap 99A. Portion 94A-2 may extend from center tap 99A to signal line 93n (e.g., the second terminal of primary coil 94A). Portion 94A-1 of primary coil 94A may be the same length as portion 94A-2 or may be a different length than portion 94A-2 (e.g., although center tap 99A is referred to herein as a center tap for the sake of simplicity, center tap 99A need not be located at the center of the length of primary coil 94A and is defined herein as a tap, path, contact, or conductor at any desired location along the length of primary coil 94A between portions 94A-1 and 94A-2).

Primary coil 94A may be magnetically coupled to secondary coil 96A with a corresponding non-zero coupling constant kA. The length of primary coil 94A relative to the length of secondary coil 96A and/or the amount of spatial overlap between primary coil 94A and secondary coil 96A may be selected to configure transformer 60A to exhibit a desired coupling constant kA. Secondary coil 96A may have the same length as primary coil 94A, may be shorter than primary coil 94A, or may be longer than primary coil 94A.

If desired, switching circuitry such as a switch 98A may be disposed on, at, or along center tap 99A between portions 94A-1 and 94A-2 of primary coil 94A. In a simplest case, for example, switch 98A may be implemented using a transistor having a first source-drain terminal coupled to portion 94A-1 of primary coil 94A, a second source-drain terminal coupled to portion 94A-2 of primary coil 94A, and a gate terminal that receives a control signal CTRLA. The terms “source” and “drain” are sometimes used interchangeably when referring to current-conducting terminals of a metal-oxide-semiconductor transistor. The source and drain terminals are therefore sometimes referred to as “source-drain” terminals (e.g., a transistor has a gate terminal, a first source-drain terminal, and a second source-drain terminal).

Control signal CTRLA may control switch 98A to place switch 98A in at least a closed state or an open state. In the closed state, switch 98A is sometimes referred to herein as being “on,” “enabled,” “closed,” or “active.” In the closed state, control signal CTRLA may assert a voltage to the gate terminal of switch 98A that configures switch 98A to exhibit less than a threshold impedance (e.g., a short circuit impedance, a zero impedance, or a very small impedance) or greater than a threshold transconductance between its first and second source-drain terminals. In the open state, switch 98A is sometimes referred to herein as being “off,” “disabled,” “open,” or “inactive.” In the open state, control signal CTRLA may provide a voltage to the gate terminal of switch 98A (e.g., a de-asserted gate voltage) that configures switch 98A to exhibit greater than a threshold impedance (e.g., an open circuit impedance, an infinite impedance, or a very high impedance) or less than a threshold transconductance between its first and second source-drain terminals.

Similarly, matching network 56B may include a second transformer 60B. Transformer 60B may include a first coil such as primary coil 94B (sometimes also referred to herein as first/primary winding 94B or first/primary inductor 94B). Transformer 60B may also include a second coil such as secondary coil 96B (sometimes also referred to herein as second/secondary winding 96B or second/secondary inductor 96B). Primary coil 94B may extend from a first terminal to a second terminal. The first terminal of primary coil 94B may be coupled to terminal 88B-1 of DAC circuit 74 over signal line 92p (e.g., a positive signal line). The second terminal of primary coil 94B may be coupled to terminal 88B-2 of DAC circuit 74 over signal line 92n (e.g., a negative signal line). Put differently, primary coil 94B may be coupled to the differential output tap 88B of RFDAC 54 (e.g., transformer 60B and matching network 56B may tap RFDAC 54 at tap 88B such that primary coil 94B is coupled in series between terminals 88B-1 and 88B-2).

Secondary coil 96B may extend from a first terminal to a second terminal. The first terminal of secondary coil 96B may be coupled to reference potential 100. The second terminal of secondary coil 96B may be coupled to output terminal 102B of matching network 56B. Output terminal 102B may be coupled to output load RL (e.g., the same output load that is coupled to output terminal 102A of matching network 56A or a different output load in transmit path 58).

Primary coil 94B may have a center tap 99B (e.g., a center tap path, contact, or conductor). Center tap 99B may separate a first portion 94B-1 of primary coil 94B (e.g., one, more than one, or less than one turn, winding, or loop of conductive material in primary coil 94B) form a second portion 94B-2 of primary coil 94B (e.g., one, more than one, or less than one turn, winding, or loop of conductive material in primary coil 94B). Portion 94B-1 may extend from signal line 92p (e.g., the first terminal of primary coil 94B) to center tap 99B. Portion 94B-2 may extend from center tap 99B to signal line 92n (e.g., the second terminal of primary coil 94B). Portion 94B-1 of primary coil 94B may be the same length as portion 94B-2 or may be a different length than portion 94B-2 (e.g., although center tap 99B is referred to herein as a center tap for the sake of simplicity, center tap 99B need not be located at the center of the length of primary coil 94B and is defined herein as a tap, path, contact, or conductor at any desired location along the length of primary coil 94B between portions 94B-1 and 94B-2).

Primary coil 94B may be magnetically coupled to secondary coil 96B with a corresponding non-zero coupling constant kB. The length of primary coil 94B relative to the length of secondary coil 96B and/or the amount of spatial overlap between primary coil 94B and secondary coil 96B may be selected to configure transformer 60B to exhibit a desired coupling constant kB. Secondary coil 96B may have the same length as primary coil 94B, may be shorter than primary coil 94B, or may be longer than primary coil 94B.

If desired, switching circuitry such as a switch 98B may be disposed at or along center tap 99B between portions 94B-1 and 94B-2 of primary coil 94B. In a simplest case, for example, switch 98B may be implemented using a transistor having a first source-drain terminal coupled to portion 94B-1 of primary coil 94B, a second source-drain terminal coupled to portion 94B-2 of primary coil 94B, and a gate terminal that receives a control signal CTRLB. Control signal CTRLB may control switch 98B to place switch 98B in at least a closed state or an open state.

Transformer 60A and matching network 56A tap signal lines 68p and 68n of RFDAC 54 at tap 88A with a first series inductance (e.g., a first inductance coupled in series between signal lines 68p/68n and the output of RFDAC 54). The presence of inductors 90 p and 90n on signal lines 84p and 84n may cause transformer 60B and matching network 56B to tap signal lines 68p and 68n at tap 88B with a second series inductance (e.g., a second inductance coupled in series between signal lines 68p/68n and the output of RFDAC 54) that is different (e.g., higher) than the first inductance. The example of FIG. 4 is illustrative and, if desired, inductors 90p and 90n may instead be disposed on signal lines 86p and 86n, respectively. Alternatively, additional inductors may be disposed on signal lines 86p and 86n that exhibit a different inductance than the inductors 90p and 90n on signal lines 84p and 84n.

The tap 88 with higher series inductance may provide a path with a higher effective capacitance C from RFDAC 54 to the corresponding matching network 56, which may be more suitable for lower frequency operation, whereas the tap 88 with lower series inductance may provide a path with a lower effective capacitance C from RFDAC 54 to the corresponding matching network 56, which may be more suitable for higher frequency operation. For example, tap 88B may provide a path with a higher effective capacitance from the output of RFDAC 54 to matching network 56B than tap 88A provides from the output of RFDAC 54 to matching network 56A. As such, matching network 56B may be tuned to lower frequencies (e.g., in frequency band BB) than matching network 56A (e.g., in frequency band BA).

When RFDAC 54 outputs radio-frequency signals from signal lines 68p and 68n in frequency band BA (e.g., at a relatively high frequency), switch 98A in transformer 60A may be closed while switch 98B in transformer 60B is open, effectively activating or enabling matching network 56A while deactivating or disabling matching network 56B from use in transmitting signals. This causes current of the radio-frequency signals to flow from signal lines 68p/68n through tap 88A, through signal lines 93p/93n, and through primary coil 94A of transformer 60A, which magnetically couples to secondary coil 96A to produce a corresponding current that flows through output terminal 102A (e.g., transformer 60A may serve as a balun that converts the differential radio-frequency signal output on tap 88A into a single-ended radio-frequency signal output at terminal 102A). Transformer 60A may also perform impedance matching between the output of RFDAC 54 and output load RL in frequency band BA (e.g., because transformer 60A is tuned to a frequency in frequency band BA). The open circuit produced by switch 98B in primary coil 94B of transformer 60B may prevent current from flowing through tap 88B, signal lines 92p/92n, and primary coil 94B of transformer 60B. Although there may still be some parasitic current that flows through switch 98B while in the open state, placing switch 98B in the open state may prevent the formation of eddy currents on transformer 60B, helping to increase isolation between output terminals 102A/102B and frequency bands BA/BB.

On the other hand, when RFDAC 54 outputs radio-frequency signals from signal lines 68p and 68n in frequency band BB (e.g., at a relatively low frequency), switch 98A in transformer 60A may be open while switch 98B in transformer 60B is closed, effectively activating or enabling matching network 56B while deactivating or disabling matching network 56A from use in transmitting signals. This causes current of the radio-frequency signals to flow from signal lines 68p/68n through tap 88B, through signal lines 92p/92n, and through primary coil 94B of transformer 60B, which magnetically couples to secondary coil 96B to produce a corresponding current that flows through output terminal 102B (e.g., transformer 60B may serve as a balun that converts the differential radio-frequency signal output on tap 88B into a single-ended radio-frequency signal output at terminal 102B). Transformer 60B may also perform impedance matching between the output of RFDAC 54 and output load RL in frequency band BB (e.g., because transformer 60B is tuned to a frequency in frequency band BB). The open circuit produced by switch 98A in primary coil 94A of transformer 60A may prevent current from flowing through tap 88A, signal lines 93p/93n, and primary coil 94A of transformer 60A. Although there may still be some parasitic current that flows through switch 98A while in the open state, placing switch 98A in the open state may prevent the formation of eddy currents on transformer 60A, helping to increase isolation between output terminals 102A/102B and frequency bands BA/BB.

The example of FIG. 4 is illustrative and non-limiting. In general, there may be N different matching networks 56 coupled to the output of signal lines 68p/68n by N different taps 88 of RFDAC 54, where each matching network 56 includes a respective transformer 60 that is tuned to a different respective one of N different frequency bands (e.g., a low band, a low-mid band, a midband, a high band, an ultra-high band, etc.). N may be any desired integer greater than or equal to one (e.g., N=1, 2, 3, 4, 5, 5-10, 10-20, 1-10, etc.). If desired, RFDAC 54 may include respective switches at each tap 88 that activate or deactivate different taps based on the frequency of the transmitted signals. If desired, switch 98A and/or switch 98B may be omitted. If desired, primary coils 94A and 94B may include multiple switches 98 coupled in series between three or more different respective portions or segments of the primary coils. If desired, multiple taps with equal inductance may be deployed in parallel to couple to the same matching network (e.g., to provide a way to reduce the series output inductance of the RFDAC, allowing for even higher frequencies of operation due to the reduced effective capacitance C). If desired, RFDAC 54 and/or the matching networks may output and/or operate on single-ended signals rather than differential signals.

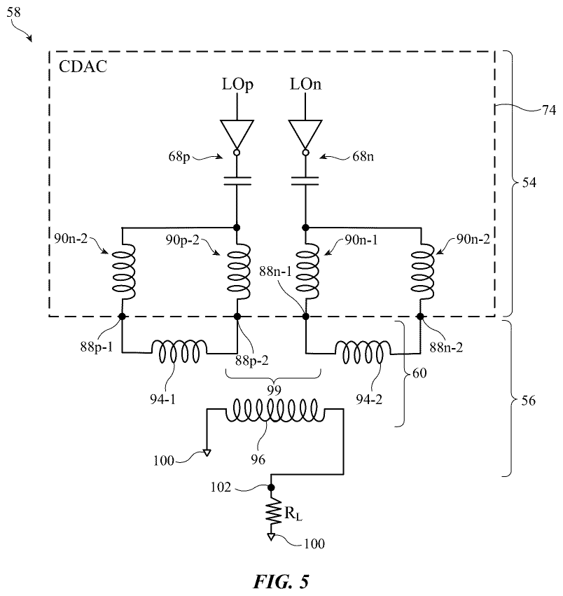

If desired, one or more of the matching networks 56 described herein may tap the output of RFDAC 54 (e.g., signal lines 68p/68n) two or more times. FIG. 5 is a circuit diagram showing one example of how RFDAC 54 may be provided with a given matching network 56 that taps RFDAC 54 twice. As shown in FIG. 5, DAC circuit 74 may include a first inductor 90p-1 coupled in series between signal line 68p and terminal 88p-1 (e.g., a first tap point of RFDAC 54) and may include a second inductor 90p-2 coupled in series between signal line 68p and terminal 88p-2 (e.g., a second tap point of RFDAC 54). In addition, DAC circuit 74 may include a third inductor 90n-1 coupled in series between signal line 68n and terminal 88n-1 (e.g., a third tap point of RFDAC 54) and may include a fourth inductor 90n-2 coupled in series between signal line 68n and terminal 88n-2 (e.g., a fourth tap point of RFDAC 54).

Matching network 56 (e.g., matching network 56A or 56B of FIG. 4) may include two differential taps of RFDAC 54, such as a first differential tap formed from terminals 88p-1 and 88n-1 and a second differential tap formed from terminals 88p-2 and 88n-2. Inductors 90p-1 through 90n-2 may each have the same inductance if desired. Transformer 60 may have a primary coil 94 that is magnetically coupled to a corresponding secondary coil 96. Secondary coil 96 may be coupled in series between reference potential 100 and output terminal 102. A first portion 94-1 of primary coil 94 may be coupled in series between terminals 88p-1 and 88p-2 (or between terminals 88p-1 and 88n-1). A second portion 94-2 of primary coil 94 may be coupled in series between terminals 88n-1 and 88n-2 (or between terminals 88p-2 and 88n-2). If desired, portion 94-1 may be separated from portion 94-2 (e.g., by an open circuit), a center tap 99 may conductively couple portion 94-1 to portion 94-2, and/or a switch 98 (e.g., switch 98A or 98B of FIG. 4) may couple portion 94-1 to portion 94-2. Double-tapping RFDAC 54 in this way may, for example, help to maximize the tuning range of RFDAC 54. Although FIG. 5 only illustrates a single matching network 56 that taps RFDAC 54 twice, in general, N different matching networks 56 (see, e.g., matching networks 56A and 56B of FIG. 4) may each tap RFDAC 54 two or more times in this way. If desired, matching network 56A may tap RFDAC 54 twice (e.g., as shown by matching network 56 of FIG. 5) whereas matching network 56B only taps RFDAC 54 once (e.g., as shown by matching network 56B in FIG. 4). Alternatively, if desired, matching network 56B may tap RFDAC 54 twice (e.g., as shown by matching network 56 of FIG. 5) whereas matching network 56A only taps RFDAC 54 once (e.g., as shown by matching network 56B in FIG. 4). If desired, multiple matching networks from the same RFDAC 54 may be multiplexed back to the same port of the RFDAC (e.g., there may be two or more different output loads RL operably coupled to one or more output terminals 102, coupled to output terminal 102A, coupled to output terminal 102B, etc.).

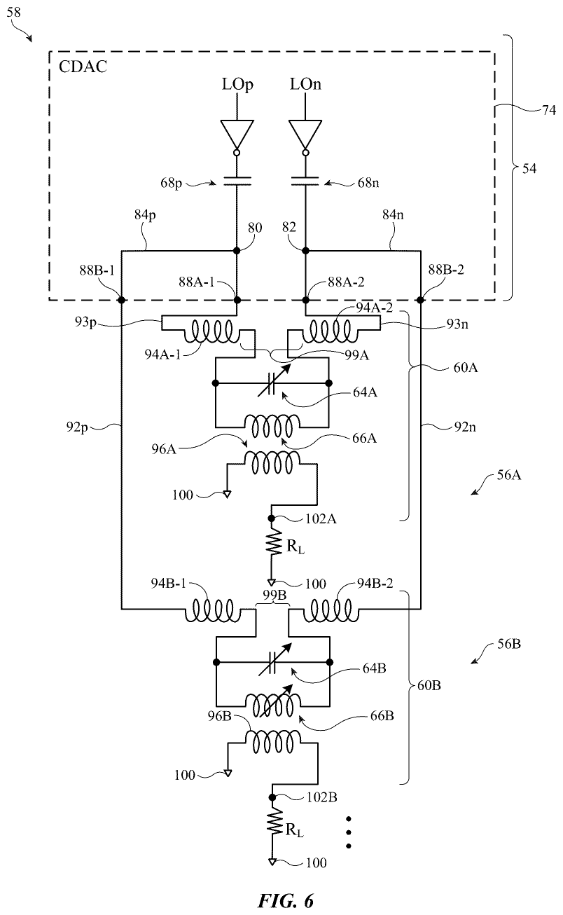

To help further tune the frequency of matching network 56A (e.g., within frequency band BA) and matching network 56B (e.g., within frequency band BB), the primary coils of the matching networks may include adjustable series-coupled capacitors and/or inductors. FIG. 6 is a diagram showing one example of how matching networks 56A and 56B of FIG. 4 may be provided with primary coils having adjustable series-coupled capacitors and inductors. In the example of FIG. 6, switches 98A and 98B of FIG. 4 have been omitted for the sake of clarity.

As shown in FIG. 6, the center tap 99A of the primary coil 94A in transformer 60A of matching network 56A may include one or more adjustable (tunable) capacitors 64A coupled in series between portions 94A-1 and 94A-2 of primary coil 94A and/or may include one or more adjustable (tunable) inductors 66A coupled in series between portions 94A-1 and 94A-2 of primary coil 94A (e.g., adjustable capacitor 64A and adjustable inductor 66A may be coupled in parallel between portions 94A-1 and 94A-2). If desired, switch 98A (FIG. 4) may be coupled in parallel with adjustable capacitor 74A and adjustable inductor 66A between portions 94A-1 and 94A-2 or may be integrated into adjustable capacitor 74A and/or adjustable inductor 66A (e.g., for selectively forming an open circuit or a short circuit impedance between portions 94A-1 and 94A-2 depending on whether matching network 56A is active or inactive).

Adjustable capacitor 64A may have a discrete or continuously adjustable capacitance that may be adjusted (e.g., using control signals CTRL of FIG. 3) to fine tune the frequency response of matching network 60A. Adjustable capacitor 64A may, for example, include a varactor or banks of switches and fixed capacitors coupled in series and/or in parallel between portions 94A-1 and 94A-2 of primary coil 94A.

Adjustable inductor 66A may have a discrete or continuously adjustable inductance that may be adjusted (e.g., using control signals CTRL of FIG. 3) to fine tune the frequency response of matching network 60A. Adjustable inductor 66A may, for example, include banks of switches and fixed inductors coupled in series and/or in parallel between portions 94A-1 and 94A-2 of primary coil 94A.

Similarly, the center tap 99B of the primary coil 94B in transformer 60B of matching network 56B may include one or more adjustable (tunable) capacitors 64B coupled in series between portions 94B-1 and 94B-2 of primary coil 94B and/or may include one or more adjustable (tunable) inductors 66B coupled in series between portions 94B-1 and 94B-2 of primary coil 94B (e.g., adjustable capacitor 64B and adjustable inductor 66B may be coupled in parallel between portions 94B-1 and 94B-2). Adjustable capacitors 64A and 64B are sometimes also referred to herein as adjustable capacitances. Adjustable inductors 66A and 66B are sometimes also referred to herein as adjustable inductances. If desired, switch 98B (FIG. 4) may be coupled in parallel with adjustable capacitor 74B and adjustable inductor 66B between portions 94B-1 and 94B-2 or may be integrated into adjustable capacitor 74B and/or adjustable inductor 66B (e.g., for selectively forming an open circuit or a short circuit impedance between portions 94B-1 and 94B-2 depending on whether matching network 56B is active or inactive).

Adjustable capacitor 64B may have a discrete or continuously adjustable capacitance that may be adjusted (e.g., using control signals CTRL of FIG. 3) to fine tune the frequency response of matching network 60B. Adjustable capacitor 64B may, for example, include a varactor or banks of switches and fixed capacitors coupled in series and/or in parallel between portions 94b-1 and 94b-2 of primary coil 94b.

Adjustable inductor 66B may have a discrete or continuously adjustable inductance that may be adjusted (e.g., using control signals CTRL of FIG. 3) to fine tune the frequency response of matching network 60B. Adjustable inductor 66B may, for example, include banks of switches and fixed inductors coupled in series and/or in parallel between portions 94B-1 and 94B-2 of primary coil 94B. In practice, the inductance of adjustable inductor 66B may be different than that of adjustable inductor 66A due to the fact that, at lower frequencies (e.g., in frequency band BB), a relatively high series inductance may be needed to obtain a desired capacitive scaling behavior. If desired, the center tap paths of one or both transformers may include one or more direct shorts (not shown) (e.g., corresponding to a state in which the adjustable inductor(s) are set to exhibit an inductance of zero). In some implementations, additional switches (not shown) may be coupled to terminals 88B-1, 88A-1, 88A-2, and/or 88B-2 to help mitigate parasitic loading of the output signal lines by whichever matching network 56 is not currently active. One or both matching networks may include two taps to RFDAC 54 (e.g., as shown by matching network 56 in FIG. 5) or may each tap RFDAC 54 more than twice (e.g., three times, four times, etc.).

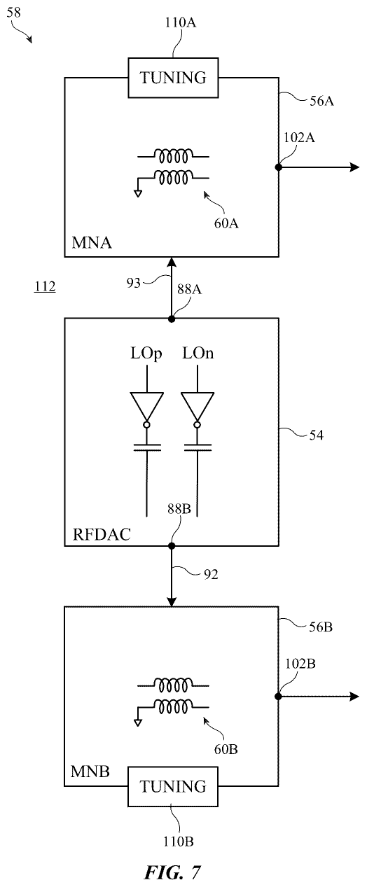

FIG. 7 is a floorplan (layout) diagram showing one example of how RFDAC 54, matching network 56A, and matching network 56B may be arranged on a corresponding substrate 112 (e.g., a semiconductor substrate such as an integrated circuit chip, a printed circuit board, a package substrate, etc.).

As shown in FIG. 7, RFDAC 54, matching network 56A, and matching network 56B may be disposed on or integrated within substrate 112. RFDAC 54 may be laterally interposed between matching network 56A and matching network 56B on substrate 112. Matching network (MN) 56A may have an input coupled to tap 88A of RFDAC 54 over signal line(s) 93 (e.g., signal lines 93p/93n of FIGS. 4 and 6). Matching network 56A may include a corresponding tuning circuit 110A for its transformer 60A. Tuning circuit 110A may include adjustable capacitor 64A (FIG. 6), adjustable inductor 66A, and/or switch 98A (FIG. 4), or may be omitted if desired.

Matching network 56B may have an input coupled to tap 88B of RFDAC 54 over signal line(s) 92 (e.g., signal lines 92p/92n of FIGS. 4 and 6). Matching network 56B may include a corresponding tuning circuit 110B for its transformer 60B. Tuning circuit 110B may include adjustable capacitor 64B (FIG. 6), adjustable inductor 66B, and/or switch 98B (FIG. 4), or may be omitted if desired. Interposing RFDAC 54 between matching networks 56A and 56B in this way may allow RFDAC 54 to utilize symmetric tapping and may help to minimize routing distance and complexity between the RFDAC and the matching networks.

When active, matching network 56A may receive radio-frequency signals in frequency band BA from RFDAC 54 over signal line(s) 93. Matching network 56A may perform impedance matching between RFDAC 54 and output load RL (FIGS. 4-6) in frequency band BA and may output the radio-frequency signals in frequency band BA to the output load via output terminal 102A. When matching network 56B is active, matching network 56B may receive radio-frequency signals in frequency band BB from RFDAC 54 over signal line(s) 92. Matching network 56B may perform impedance matching between RFDAC 54 and output load RL (FIGS. 4-6) in frequency band BB and may output the radio-frequency signals in frequency band BB to the output load via output terminal 102B.

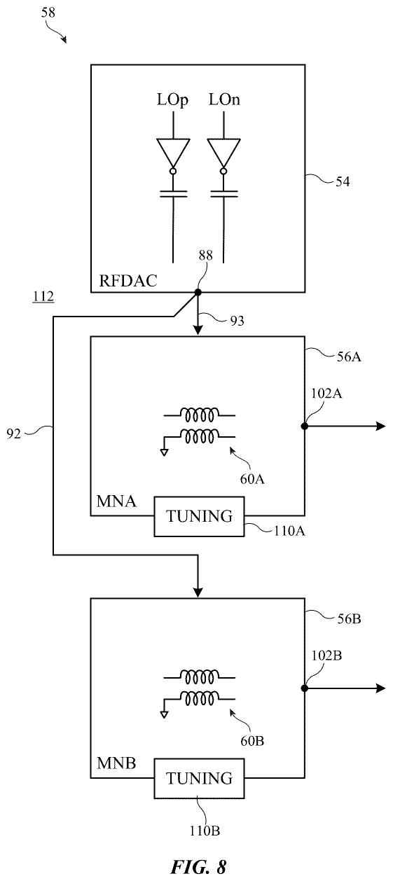

The example of FIG. 7 in which matching networks 56 are disposed on opposing sides of RFDAC 54 is illustrative and non-limiting. FIG. 8 is a floorplan (layout) diagram showing another example of how RFDAC 54, matching network 56A, and matching network 56B may be arranged on substrate 112. As shown in FIG. 8, matching network 56A may be laterally interposed between RFDAC 54 and matching network 54B on substrate 112. RFDAC 54 may include a bifurcated tap 88 that is coupled to both matching network 56A over signal line(s) 93 and matching network 56B over signal line(s) 92 that are routed around matching network 56A (e.g., a signal splitter or signal coupler may couple tap 88 to both signal line(s) 92 and signal line(s) 93).

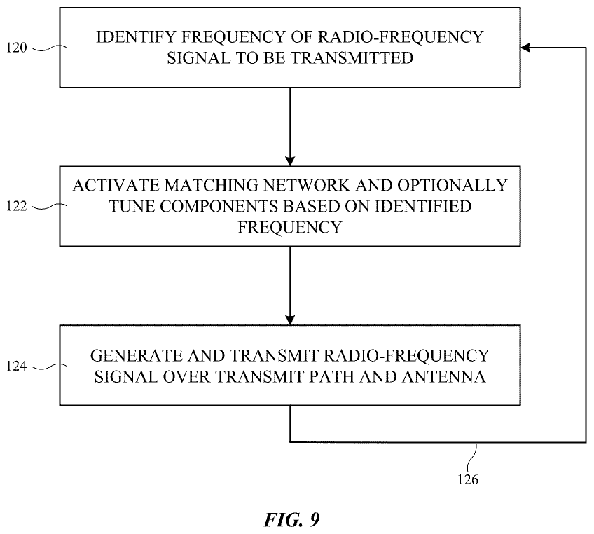

FIG. 9 is a flow chart of illustrative operations involved in transmitting radio-frequency signals using transmit path 58 of FIGS. 3-8. At operation 120, control circuitry 14 (FIG. 1) may identify a frequency of the radio-frequency signal to be transmitted over transmit path 58. This may include identification of a corresponding frequency band for the transmitted signal (e.g., frequency band BA or BB of FIG. 4) and, if desired, identification of a corresponding frequency within the frequency band. The frequency of the radio-frequency signal to be transmitted may be determined by a communication schedule for device 10 (e.g., as maintained by a wireless network), by one or more applications running on device 10, by one or more communications requirements imposed on device 10, etc.

At operation 122, control circuitry 14 may activate a given matching network 56 coupled to the output of RFDAC 54 based on the identified frequency band for the transmitted signal. Control circuitry 14 may activate a given matching network 56 by closing the switch 98 in the primary coil 94 of the transformer 60 in that matching network 56. Control circuity 14 may deactivate a given matching network 56 by opening the switch 98 in the primary coil 94 of the transformer 60 in that matching network 56. For example, if/when control circuitry 14 identifies that the signal is to be transmitted in band BA, control circuitry 14 may activate matching network 56A (FIGS. 4 and 6-8) while deactivating matching network 56B. On the other hand, if/when control circuitry 14 identifies that the signal is to be transmitted in band BB, control circuitry 14 may activate matching network 56B while deactivating matching network 56A. In addition, if desired, control circuitry 14 may adjust the adjustable inductor 66 and/or the adjustable capacitor 64 in the activated matching network 56 and/or may adjust one or more adjustable inductors 70 and/or capacitors 72 (FIG. 3) in RFDAC 54 to fine tune the matching network to match the particular frequency within the identified frequency band for the transmitted signal.

At operation 124, transmit path 58 may generate and transmit radio-frequency signals at the identified frequency via RFDAC 54 and the active matching network 56. Amplifier 50 may amplify the radio-frequency signal and antenna 42 may radiate the radio-frequency signal (FIG. 3). Processing may loop back to operation 120 via path 126 as the frequency of the transmitted signal changes over time.

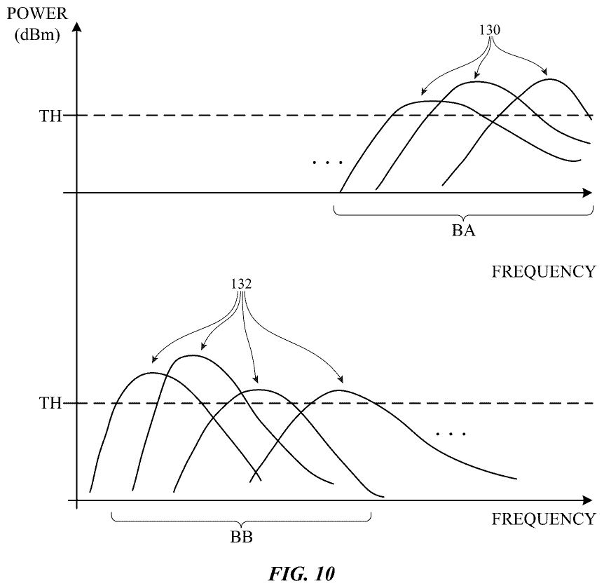

FIG. 10 is a plot of the output power of matching network(s) 56 and RFDAC 54 as a function of frequency while transmitting radio-frequency signals. Curves 130 plot the performance of the transmit path while matching network 56A is active and matching network 56B is inactive (e.g., where each curve 130 corresponds to a different configuration of adjustable inductor 66A, adjustable capacitor 64A, and/or adjustable components within the RFDAC). As shown by curves 130, the transmit path may transmit the signals at power levels exceeding threshold TH (e.g., 17 dBm) at different frequencies across frequency band BA when matching circuit 56A, which is tuned/optimized to perform impedance matching in frequency band BA, is active.

Curves 132 plot the performance of the transmit path while matching network 56B is active and matching network 56A is inactive (e.g., where each curve 132 corresponds to a different configuration of adjustable inductor 66B, adjustable capacitor 64B, and/or adjustable components within the RFDAC). As shown by curves 132, the transmit path may transmit the signals at power levels exceeding threshold TH at different frequencies across frequency band BB when matching circuit 56B, which is tuned/optimized to perform impedance matching in frequency band BB, is active. By providing RFDAC 54 with different matching networks tuned to different frequency bands that each tap the output of signal lines 68p/68n (e.g., utilizing a multi-tap approach), RFDAC 54 may generate and transmit radio-frequency signals at sufficiently high power levels (e.g., exceeding threshold TH) across a relatively wide range of frequencies (e.g., from around 700 MHz to around 7-12 GHz or higher, across at least frequency bands BA and BB). This may be generalized to N different matching networks for tuning the RFDAC across N different frequency bands. The example of FIGS. 4-10 in which different matching networks 56 of the same RFDAC 54 (e.g., matching networks 56A and 56B) operate in different frequency bands (e.g., frequency bands BA and BB) is illustrative and non-limiting. If desired, different matching networks 56 of the same RFDAC 54 (e.g., matching networks 56A and 56B) may operate in the same frequency band (e.g., in implementations where different matching networks 56 are switched into use for providing the RFDAC with different levels of output power level while amplifying radio-frequency signals in the same frequency band).

The methods and operations described above in connection with FIGS. 1-10 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 and/or wireless communications circuitry 24 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry in wireless circuitry 24, processing circuitry 18 of FIG. 1, etc.). The processing circuitry may include microprocessors, application processors, digital signal processors, central processing units (CPUs), application-specific integrated circuits with processing circuitry, or other processing circuitry.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. Wireless circuitry comprising:
a digital-to-analog converter (DAC) circuit that includes a signal path configured to output an analog radio-frequency signal;
a first matching network that includes a first transformer with a first primary coil coupled to the signal path at a first tap of the DAC circuit, the first matching network being tuned to a first frequency band; and
a second matching network that includes a second transformer with a second primary coil coupled to the signal path at a second tap of the DAC circuit, the second matching network being tuned to a second frequency band lower than the first frequency band.

2. The wireless circuitry of claim 1, further comprising:
a first adjustable inductor coupled in series between a first portion of the first primary coil and a second portion of the first primary coil.

3. The wireless circuitry of claim 2, further comprising:
a first adjustable capacitor coupled in series between the first portion of the first primary coil and the second portion of the first primary coil in parallel with the first adjustable inductor.

4. The wireless circuitry of claim 3, further comprising:
a second adjustable inductor coupled in series between a first portion of the second primary coil and a second portion of the second primary coil; and
a second adjustable capacitor coupled in series between the first portion of the second primary coil and the second portion of the second primary coil in parallel with the second adjustable inductor.

5. The wireless circuitry of claim 1, further comprising:
an adjustable capacitor coupled in series between a first portion of the first primary coil and a second portion of the first primary coil.

6. The wireless circuitry of claim 1, further comprising:
a first switch coupled in series between a first portion of the first primary coil and a second portion of the first primary coil; and
a second switch coupled in series between a first portion of the second primary coil and a second portion of the second primary coil.

7. The wireless circuitry of claim 6, further comprising:
one or more processors configured to close the first switch and open the second switch when the analog radio-frequency signal is in the first frequency band and configured to open the first switch and close the second switch when the analog radio-frequency signal is in the second frequency band.

8. The wireless circuitry of claim 1, wherein the DAC circuit comprises an inductor coupled in series between the signal path and second matching network.

9. The wireless circuitry of claim 8, wherein the DAC circuit exhibits a first series inductance between the signal path and the first matching network and exhibits a second series inductance between the signal path and the second matching network, the second series inductance being higher than the first series inductance.

10. The wireless circuitry of claim 1, wherein the signal path comprises a differential signal path having a positive signal line and a negative signal line, the first tap includes a first output terminal and a second output terminal of the DAC circuit, the second tap includes a third output terminal and a fourth output terminal of the DAC circuit, the first output terminal and the third output terminal are communicatively coupled to the positive signal line in parallel, and the second output terminal and the fourth output terminal are communicatively coupled to the negative signal line in parallel.

11. The wireless circuitry of claim 10, wherein:
the first transformer includes a first secondary coil coupled between a reference potential and a first output of the first matching network,
the first primary coil is coupled in series between the first and second output terminals of the DAC circuit,
the second transformer includes a second secondary coil coupled between the reference potential and a second output of the second matching network, and
the second primary coil is coupled in series between the third and fourth output terminals of the DAC circuit.

12. The wireless circuitry of claim 1, further comprising:
a power amplifier, wherein the first matching network and the second matching network are coupled between the DAC circuit and an input of the power amplifier.

13. Wireless circuitry comprising:
a digital-to-analog converter (DAC) that includes a differential signal path having a positive signal line and a negative signal line configured to output an analog radio-frequency signal;
a first transformer that includes a first primary coil and a first secondary coil, wherein the first primary coil is coupled in series between the positive signal line and the negative signal line, the first secondary coil is coupled between a reference potential and an output load, and the first transformer is tuned to a first frequency band; and
a second transformer that includes a second primary coil and a second secondary coil, wherein the second primary coil is coupled in series between the positive signal line and the negative signal line in parallel with the first primary coil, the second secondary coil is coupled between the reference potential and the output load, and the second transformer is tuned to a second frequency band lower than the first frequency band.

14. The wireless circuitry of claim 13, wherein the DAC has a first series inductance between the positive signal line and the first transformer, the DAC has the first series inductance between the negative signal line and the first transformer, the DAC has a second series inductance greater than the first series inductance between the positive signal line and the second transformer, and the DAC has the second series inductance between the negative signal line and the second transformer.

15. The wireless circuitry of claim 13, wherein the output load comprises a power amplifier.

16. The wireless circuitry of claim 13, further comprising:
a first switch coupled in series between a first portion of the first primary coil and a second portion of the first primary coil, wherein the first switch is open when the analog radio-frequency signal is in the second frequency band and is closed when the analog radio-frequency signal is in the first frequency band; and
a second switch coupled in series between a first portion of the second primary coil and a second portion of the second primary coil, wherein the second switch is open when the analog radio-frequency signal is in the first frequency band and is closed when the analog radio-frequency signal is in the second frequency band.

17. The wireless circuitry of claim 13, further comprising:
a substrate, wherein the DAC, the first transformer, and the second transformer are disposed on the substrate, the DAC being laterally interposed between the first transformer and the second transformer on the substrate;
a first signal path that couples the primary coil of the first transformer to a first tap of the DAC; and
a second signal path that couples the primary coil of the second transformer to a second tap of the DAC that is different from the first tap.

18. The wireless circuitry of claim 13, further comprising:
a substrate, wherein the DAC, the first transformer, and the second transformer are disposed on the substrate, the first transformer being laterally interposed between the second transformer and the DAC on the substrate;
a first signal path that couples the primary coil of the first transformer to a bifurcated tap of the DAC; and
a second signal path that couples the primary coil of the second transformer to the bifurcated tap of the DAC.

19. Wireless circuitry comprising:
a digital-to-analog converter (DAC) that includes
a differential signal path having a first line and a second line configured to output an analog radio-frequency signal,
a first inductor coupled in series between the first line and a first terminal of the DAC,
a second inductor coupled in series between the first line and a second terminal of the DAC,
a third inductor coupled in series between the second line and a third terminal of the DAC, and
a fourth inductor coupled in series between the second line and a fourth terminal of the DAC; and
a transformer that includes
a first coil coupled in series between the first terminal and the third terminal,
a second coil coupled in series between the second terminal and the fourth terminal, and
a third coil coupled in series between a reference potential and an output load and that is electromagnetically coupled to the first coil and the second coil.

20. The wireless circuitry of claim 19, further comprising:
an additional transformer having a fourth coil that is coupled in series between the first line and the second line and having a fifth coil that is coupled between the reference potential and the output load, wherein the transformer is tuned to a first frequency band and the additional transformer is tuned to a second frequency band that is different from the first frequency band.
